(19) United States
(12) Patent Application Publication
(10) Pub. No.: US 2012/0293528 A1
(43) Pub. Date: Nov. 22, 2012

(54) METHOD AND APPARATUS FOR RENDERING A PAPER REPRESENTATION ON AN ELECTRONIC DISPLAY

(76) Inventor: Eric J. LARSEN, Pacifica, CA (US)

(21) Appl. No.: 13/110,475

(22) Filed: May 18, 2011

(51) Int. Cl. G09G 5/00; G09G 5/02

(52) U.S. Cl. 345/589; 345/156

(57) ABSTRACT

A display apparatus having a surface that displays image data. A processing device processes and provides image data to the display. A camera device is associated with the display and the processing device. The camera device dynamically detects a user's head position relative to the surface of the display and determines the incident light surrounding the display. The detected head position and the incident light are then processed by the processing device for rendering the image data on the display to resemble a representation of an actual paper medium.

### BACKGROUND

1. Field of the Invention

This invention relates generally to electronic display devices, and more specifically, to enhancing the representation of image data on electronic display devices.

2. Background Discussion

Typically, reading text on an active light display appears to increase eye strain in comparison to reading print from actual paper media. In addition, for example, some users of electronic reading devices may have a personal preference for the appearance associated with an actual paper medium as opposed to the look of electronic image data (e.g., text) displayed on an electronic display such as a computer screen, PDA, E-Reader, smart phone, etc.

Thus, embodiments of the present invention are directed to enhancing the visual representation of image data on an electronic display.

### SUMMARY

Accordingly, embodiments of the present invention are directed to a method and apparatus that is related to enhancing the representation of image data that is displayed on an electronic display. Particularly, according to embodiments of the present invention, image data may be displayed on an electronic display in a manner that simulates the visual appearance of an actual paper medium (e.g., paper utilized in printed novels).

One embodiment of the present invention is directed to an apparatus including a display having a surface that displays image data. A processing device processes and provides image data to the display. A camera device is associated with the display and operatively coupled to the processing device. The camera device dynamically detects a user's head position relative to the surface of the display and determines the incident light surrounding the display. The detected head position and the incident light are then processed by the processing device for rendering the image data on the display to resemble a representation of an actual paper medium.

Another embodiment of the present invention is directed to a method of controlling the appearance on a display having a surface that displays image data. The method includes determining incident light levels surrounding the display. A user's head position is then determined relative to the surface of the display. The incident light levels and the user's head position are processed for rendering image data on the display that resembles a representation of an actual paper medium.

Yet another embodiment of the present invention is directed to determining the user's eye position, and providing, based on the user's determined eye position, enhanced lighting to a first region of the display where the user is predicted to be observing. Based on the user's determined eye position, shading to a second region of the display where the user is predicted to not be observing.

Yet another embodiment of the present invention is directed to calculating a time period corresponding to an interval between the user changing page content associated with the display and advancing to a next page of content and predicting the region of the display where the user is observing based on the calculated time period and the user's determined eye position. For example, when a user finishes reading a page of image data (e.g., text of book) and manually activates the device (e.g., e-reader) to display the next page of text, the time interval between such display events may be used to predict how long it takes for the user to complete the process of reading a page of displayed text on the display. The time it takes for the user to complete the process of reading a page may be defined as the above described time period. Further, an average value of such a time period may also be used to account for a user's decreased reading speed at the end of a reading session compared to when the user first begins to read. Using this calculated time period, an automatic function may cause the device to change the displayed text to the next page automatically without the need for the user to manually activate the device (e.g., e-reader) to display the next page of text. Also, assuming that a user reads the displayed text from the top of the display to the bottom of the display according to a substantially constant speed, the device may be able predicted and highlight what region or sentence the user is reading. Alternatively, reasonably accurate systems using infrared sources and infrared cameras are available for detecting where the user is reading.

Yet another embodiment of the present invention is directed to providing a book genre and providing simulated effects based on the provided book genre. The simulated effects may include media data that is reproduced based on the user observing a particular one or more locations on the display that are determined by the predicting of the region of the display where the user is observing.

Yet another embodiment of the present invention is directed to saving the calculated time period with user-login information associated with the user, and accessing the calculated time period upon the user entering the user-login information. The accessed time period and a further eye position determination are utilized for predicting the region of the display where the user is observing.

Yet another embodiment of the present invention is directed to providing a book genre and processing the book genre such that the rendered image data on the display resembles the representation of an actual paper medium corresponding to the provided book genre. The processing may include graphically displaying a binding at a middle location of the representation of an actual paper medium such that content data associated with the image data is enlarged in the proximity of the graphically displayed middle binding.

Yet another embodiment of the present invention is directed to a non-transitory computer-readable recording medium for storing a computer program for controlling the appearance on a display having a surface that displays image data. The program includes determining incident light levels surrounding the display; determining a user's head position relative to the surface of the display; and then processing the incident light levels and the user's head position for rendering image data on the display that resembles a representation of an actual paper medium.

Yet another embodiment of the present invention is directed an apparatus comprising a display having a surface that displays image data; a processing device for processing and providing image data to the display; and a camera device associated with the display and communicatively coupled to the processing device. The camera device dynamically detects changes in a user's head position and changes in movement of at least one of the user's eyes in order to provide a dynamic bookmark. The dynamic bookmark may include a highlighted portion of displayed text that is determined based on the processing of the detected changes in the user's head position and the changes in the movement of at least one of the user's eyes.

Other embodiments of the present invention include the methods described above but implemented using apparatus or programmed as computer code to be executed by one or more processors operating in conjunction with one or more electronic storage media.

### BRIEF DESCRIPTION OF THE DRAWINGS

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages, embodiments and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 illustrates a block diagram of an electronic display generating apparatus according to an embodiment of the present invention;

FIG. 2 is a block diagram of the image effects generating unit according to an embodiment of the present invention;

FIG. 3 is an operational flow diagram of an apparatus according to an embodiment of the present invention;

FIG. 4 is an operational flow diagram for generating additional visual data according to an embodiment of the present invention;

FIGS. 5A and 5B illustrate displayed exemplary visual data that is generated according to an embodiment of the invention;

FIG. 6 illustrates other displayed exemplary visual data that is generated according to an embodiment of the invention;

FIG. 7 illustrates an embedded graphical icon generated according to an embodiment of the invention; and

FIGS. 8A-8D illustrate angular relationships between a user of the apparatus and an electronic display according to an embodiment of the invention.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from and encompassed by, the following description. As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

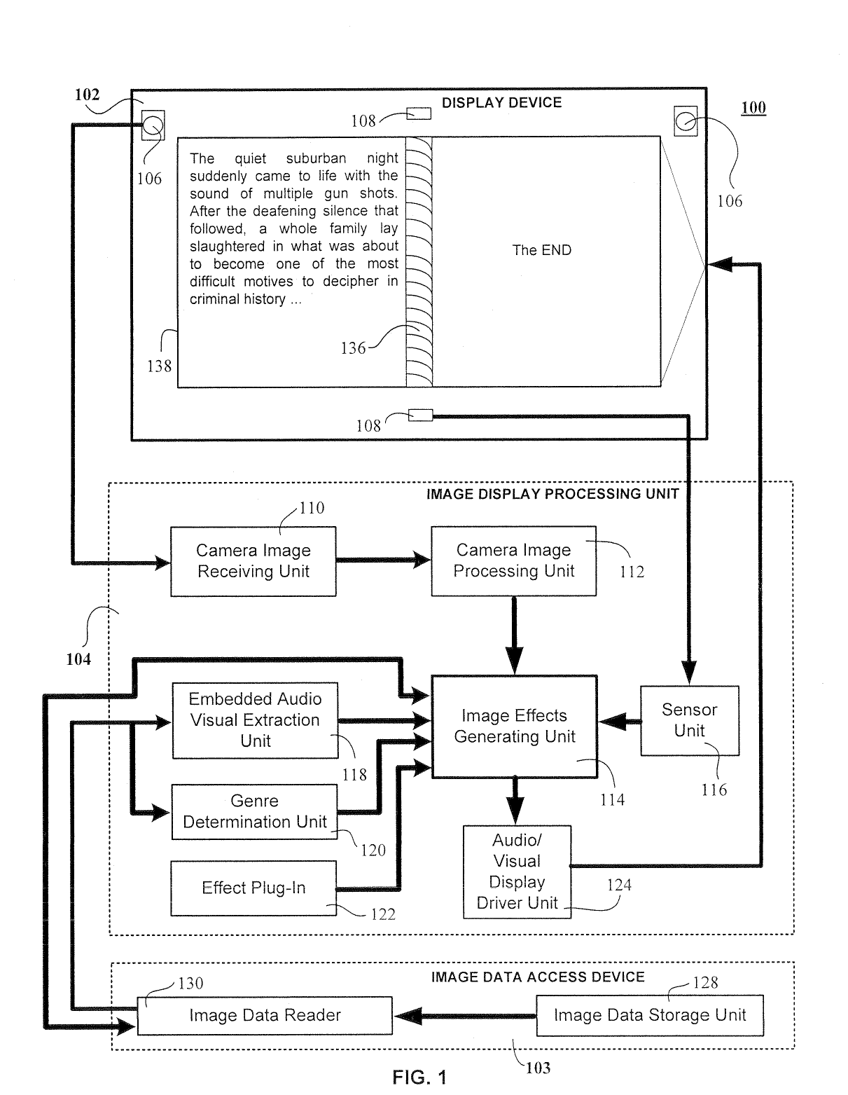

FIG. 1 illustrates a block diagram of an electronic display generating apparatus 100 according to an embodiment of the present invention. The electronic display generating apparatus 100 includes an electronic display 102 and an image processing unit 104 that drives the electronic display 102. The electronic display generating apparatus 100 also includes an image data access device 103 for providing image data to the image processing unit 104 for processing and reproduction on the electronic display 102.

In the context of embodiments of the present invention, the electronic display 102 may represent any powered (e.g., powered by battery, powered by a power supply adaptor, and/or powered by an alternative energy source such as solar energy) or unpowered (e.g., no internal power source) display medium that is operatively driven by a processing device (e.g., computer, PDA, cell-phone, smart-phone, e-reader, etc.). The electronic display device 102 may be, for example, an LCD, plasma or any display unit suitable to display text data, data represented by pixels or image data and/or a combination thereof. The electronic display 102 and image processing unit 104 may be integrated within a single unit such as an e-reader. Alternatively, the electronic display 102 and image processing unit 104 may be formed by separate components such as a computer tower and a computer monitor. The electronic display 102 includes one or more camera image sensors 106 (e.g., a CCD or a CMOS active-pixel sensor), and one or more additional sensor devices 108 (e.g., a microphone or accelerometer).

As shown in FIG. 1, image processing unit 104 includes a camera image receiving unit 110, a camera image processing unit 112, an image effects generating unit 114, a sensor unit 116, an embedded audio visual extraction unit 118, a genre determination unit 120, an effect plug-in unit 122, and an audio visual display driver unit 124. As shown in FIG. 1, the units 114, 116, 118, 120, 122 and 124 may be used as integral units or “add-on” units that may be accessed from an external location either via a network (Internet) or remote storage medium such as a flash drive, CD, memory stick or other computer-readable medium.

The image data access device 103 includes an image data storage unit 128 and an image data reader 130. The image data storage unit 128 may include any memory storage device (e.g., Compact Flash Memory device) capable of storing the image data that is to be displayed on the electronic display 102. Image data reader 130 includes the requisite circuitry for accessing or reading the image data from the image data storage unit 128.

Once read, the image data reader 130 sends the image data directly to the image effects generating unit 114. The image data reader 130 also simultaneously sends the image data to the embedded audio visual extraction unit 118 and the genre determination unit 120 for additional processing. The image effects generating unit 114 displays the image data on the electronic display 102 in such a manner that the image data on the display 102 simulates or resembles the representation of an actual paper medium. For example, a representation of an actual paper medium may include reproducing the appearance of the pages of, for example, a paperback novel, a hardback novel, children's books, etc. The image effects generating unit 114 also displays the image data with additional visual and/or audio effects based on the processing results from the embedded audio visual extraction unit 118 and the genre determination unit 120.

The embedded audio visual extraction unit 118 searches for and extracts audio and/or visual files that are embedded in the image data that is received from the image access device 103. For example, image data associated with displaying the text of a book may include an embedded visual file that produces a customized graphical appearance associated with the printed version of the book. Alternatively, for example, the embedded visual file may produce a highlighted-link for certain textual words. By opening the highlighted-link, the user is able to obtain additional information corresponding to the textual word represented by the link. For example, if the link associated with the word is “the Cotwolds,” by selecting this link, a screen overlay may appear within the display area 138, which provides additional information regarding the Cotwolds region of England. The embedded visual file may also produce a hyperlink for certain textual words. By opening the highlighted-link, the user is able to obtain additional information corresponding to the textual word from over the internet. For example, if the hyperlink associated with the word is “the Cotwolds,” by selecting this link, a web-browser may appear on the display, which receives additional downloaded information regarding the Cotwolds region of England. According to another example, image data associated with displaying the text of the book may include an embedded audio file that provides mood music that corresponds to the particular passage of the story line. For instance, if the textual passage displayed on the electronic display 102 corresponds to a death, the audio file will include a slow melancholy playback tune.

The genre determination unit 120 determines the genre of the image data that is read from the image data reader 130. This determination may be ascertained by, for example, analyzing the text associated with the image data, or by accessing metadata that may accompany the image data and provide genre information.

The effect plug-in 122 also provides a means for updating or adding additional visual and/or audio effects to the image data that is reproduced by the image effects generating unit 114. For example, one type of plug-in option may visually generate a center binding 136 to be displayed within the display area 138 of the electronic display 102. Another type of plug-in option may, for example, visually generate a three-dimensional effect, whereby the background of any displayed text appears to drop away from the text and into a swirling depth (not shown).

The embedded audio visual extraction unit 118, the genre determination unit 120, and the effect plug-in 122 all provide additional functionality and visual effects to the image data. However, the functionality of one or more of these units 118, 120, 122 may be enabled or disabled at the discretion of the user of the apparatus 100. Even if the functionality of all of units 118, 120, and 122 is disabled, the main function of the apparatus 100, which includes the rendering of image data on an electronic display to resemble an actual paper medium, remains intact via the processing capabilities of the image effects generating unit 114. Such a rendering of image data on an electronic display provides a reduction in eye strain, where the eye strain is generally caused by, among other things, the glare generated by existing electronic display devices.

Once the image data has been processed by the image effects generating unit 114 and optionally by any one or more of the other additional units 118, 120, 122, the audio/visual display unit driver 124 formats the image data for being displayed on the electronic display 102. Additionally, the audio/visual display unit driver 124 may process any audio data that is embedded within or accompanies the image data for the purpose of playing back such audio data via any speakers (not shown) associated with the apparatus 100.

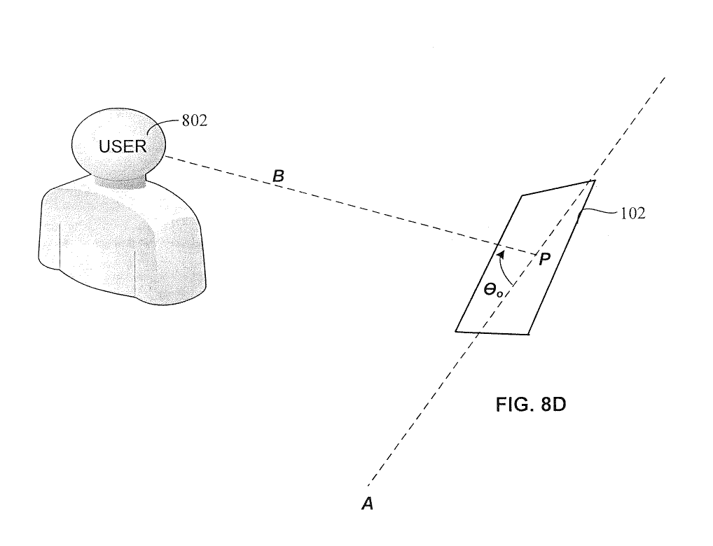

The camera image receiving unit 110 receives image frames from one or both of the camera image sensors 106. The camera image sensors 106 are operative to generate image frames of a user's head relative to the electronic display 102. The camera image sensors 106 are also adapted to provide a measure of the incident light surrounding the electronic display 102. For example, the camera image receiving unit 110 may include a data buffering device that buffers the received image frames. The camera image processing unit 112 retrieves the buffered image frames from the camera image receiving unit 110 for further digital signal processing. For example, the digital signal processing may include determining the user's head within each frame using image recognition techniques and providing a measure of the angular relationship between the user's head and the surface of the electronic display 102 (see FIG. 8).

As shown in FIG. 8A, axis A passes within the surface of the display 102 while axis B extends from the user's head 802 to the intersection point P with axis A. The angle 01 between the two axes is the angular relationship between the user's head and the surface of the electronic display 102. As shown in FIGS. 8B-8C, the angular relationships (i.e., θ2, θ3) change based on how the user orients the display 102 with respect to the head 802. Based on the user's determined head position relative to the electronic display 102 and the incident light surrounding the electronic display 102, the image effects generating unit 114 (FIG. 1) may then generate a rendering of the image data that resembles the representation of the an actual paper medium under an optimal lighting condition. For example, the optimal lighting condition may include a simulated lighting that corresponds to a passively lit room. Furthermore, in addition to simulating lighting conditions and reproducing the representation of an actual paper medium, the rendered image data compensates for changes in light level as a function of changes in the angular relationship between the user's head and the surface of the electronic display 102 (see FIG. 8).

The other rendering properties utilized by the image effects generating unit 114 may include the visual properties associated with the actual ink that is used on a particular paper medium, the simulation of the diffuse appearance associated with some paper media, and the simulation of various lighting conditions favoring a person's eye sight when reading a paper copy of a book.

Referring back to FIG. 1, sensor unit 116 receives sensory information from the sensors 108 that are located on the electronic display 102. The sensors 108 may provide one or more sensory functions, such as sensing voice (e.g., microphone), acceleration (e.g., accelerometer), temperature (e.g., temperature sensor), and/or light (e.g., light sensor). The sensor unit 116 processes the sensory information in order to send a corresponding command to the image effects generating unit 114.

For example, a signal from an accelerometer (not shown) may be transferred to the image effects generating unit 114 for the purpose of commanding the unit 114 to display the next page of rendered image data on the electronic display 102. According to another example, a signal from a temperature sensor (not shown) may be transferred to the image effects generating unit 114 for the purpose of commanding the unit 114 to temporarily freeze (i.e., pause until reactivated) the rendered image data on the electronic display 102. In this scenario, a predefined change in temperature will likely indicate that the user has moved from their current location momentarily (e.g., stepping off a train, stepping out of the house into the open air, etc.). A microphone (not shown) may facilitate receiving voice commands from the user. For example, the sensor unit 116 may receive voice command signals from the microphone and generate a corresponding command (i.e., load next page of rendered image data) using voice recognition technology. Also, a light sensor (not shown) may be utilized to detect sudden changes in the surrounding light. By receiving such changes, the sensor unit 116 may generate a compensation command to the image effects generating unit 114. For example, the compensation command may instruct the image effects generating unit 114 to momentarily (e.g., up to approximately 20 seconds) dim the electronic display in response to bright light suddenly surrounding the electronic display 102. Alternatively, for example, the compensation command may instruct the image effects generating unit 114 to momentarily (e.g., up to approximately 20 seconds) brighten the electronic display in response to a sudden drop in light surrounding the electronic display 102. Thus, as shown in FIG. 1, the sensor unit 108 is able to sense the orientation of the device 100. The camera image processing unit 112 may be used to generate an environment map of the lighting around the device 100, based on the orientation of the device. Other factors that may be used, in addition to the orientation of the device include, for example, sensed light, such as from an illumination source, tilt of the device, shading, and the user's head position. Therefore, even if the camera image receiving unit 110 is in an “OFF” state, or inoperative, the orientation of the device 100 may be tracked and the saved environment map may be used for lighting purposes.

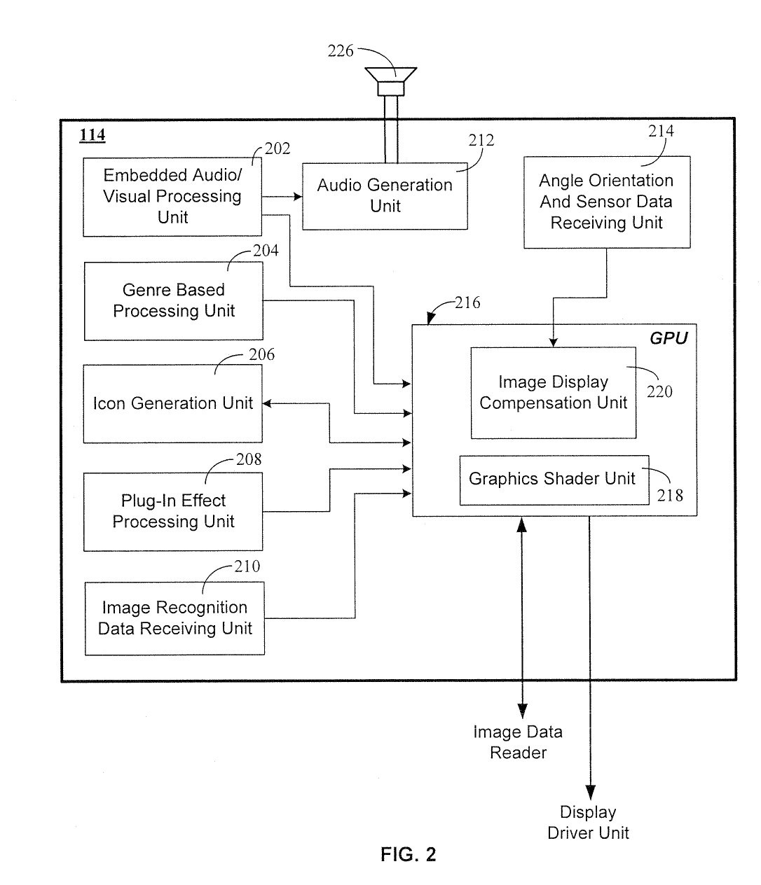

FIG. 2 is a block diagram of the image effects generating unit 114 (FIG. 1) according to an embodiment of the present invention. The image effects generating unit 114 includes an embedded audio/visual processing unit 202, a genre based processing unit 204, an icon generation unit 206, a plug-in effect processing unit 208, an image recognition data receiving unit 210, an audio generation unit 212, an angle orientation and sensor data receiving unit 214, and a graphics processing unit 216. The graphics processing unit (GPU) 216 further includes a graphics shader unit 218 and an image display compensation unit 220.

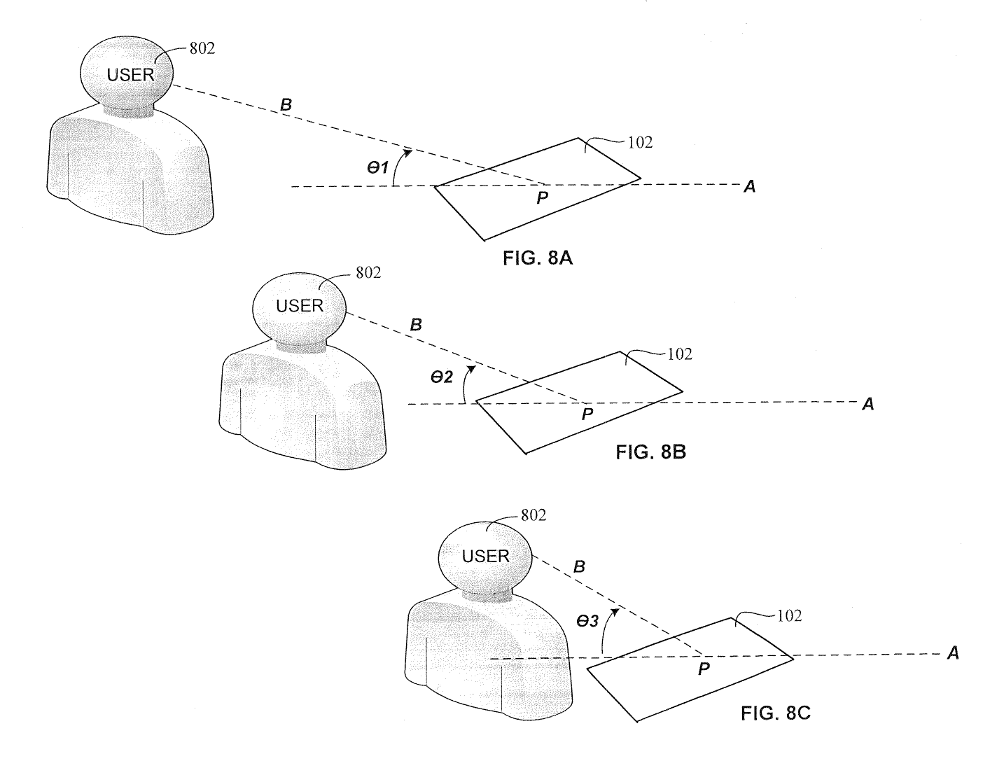

The embedded audio/visual processing unit 202 receives the audio and/or visual files or metadata that are extracted by the embedded audio/visual extraction unit (shown as element 118 in FIG. 1). The embedded audio/visual processing unit 202 then executes these audio/visual files or processes the metadata in order to, for example, generate audio and/or visual icons, and provide coordinate information corresponding to the display location of these audio and/or visual icons within the display area 138 (FIG. 1) of the electronic display 102 (FIG. 1). The executed audio/visual files also provide set-up options for allowing a user to enable or disable the display and execution of audio/visual content that is displayed and available within the display area 138 (FIG. 1). Moreover, the set-up options for allowing the user to enable the display and execution of audio/visual content may also provide for an automatic playback of such content. For example, referring to FIG. 7, an embedded audio/visual file generates an aircraft shaped icon 702 that corresponds to a particular aircraft specified as bolded or highlighted displayed text 704. According to one set-up option, the icon and the bolded/highlighted displayed text 704 may be disabled and not displayed. According to another set-up option, the icon and the bolded/highlighted displayed text 704 may be enabled and automatically activated when it is predicted that the user is reading in the vicinity of the bolded/highlighted displayed text 704. Once the icon 702 is automatically activated, a segment of visual (pictures or video) and/or audio (aircraft description/history) data content is reproduced for the user. According to other set-up options, the icon 702 and the bolded/highlighted displayed text 704 may be enabled and activated by the user selecting (e.g., using a touch screen) the icon 702 or bolded/highlighted displayed text 704. The embedded audio/visual processing unit 202 provides the necessary programming to the GPU 216 for displaying the icon and any reproducible visual data content associated with the icon. The embedded audio/visual processing unit 202 also provides the processed audio data to the audio generation unit 212 for playback through one or more speakers 226 associated with the electronic display generating apparatus 100 (FIG. 1).

The genre based processing unit 204 generates display artifacts and visual effects based on detected genre information received from the genre determination unit (FIG. 1, element 120). The genre based processing unit 204 then provides the necessary programming to the GPU 216 for displaying such artifacts and effects. For example, once a horror story's image data is utilized by the genre determination unit (FIG. 1, element 120) for specifying a “horror genre,” the genre based processing unit 204 generates a gothic-like display effect in order to intensify the reader's senses according to this detected horror genre.

The icon generation unit 206 provides the option of generating one or more icons within, for example, the border of the display area (FIG. 1, element 138). The generated icons may include various set-up options for displaying the image data. The icon generation unit 206 may also generate icons by detecting certain keywords within the displayed text of the image data. For example, if the icon generation unit 206 detects the word “samurai” within the text, it will search for and retrieve a stored URL and corresponding icon associated with the word “samurai”. Once the icon generation unit 206 displays the icon, by clicking on the icon, the user will be taken to the URL site which provides, for example, historical information about the samurai. The icon generation unit 206 may also detect and highlight certain keywords within the displayed text of the image data. For example, if the icon generation unit 206 detects the word “samurai” within the text, it will highlight this word and convert it to a URL that provides a link to information corresponding to the samurai. Alternatively, the icon generation unit 206 may highlight the word “samurai” and provide a path to a memory location that stores information on the samurai.

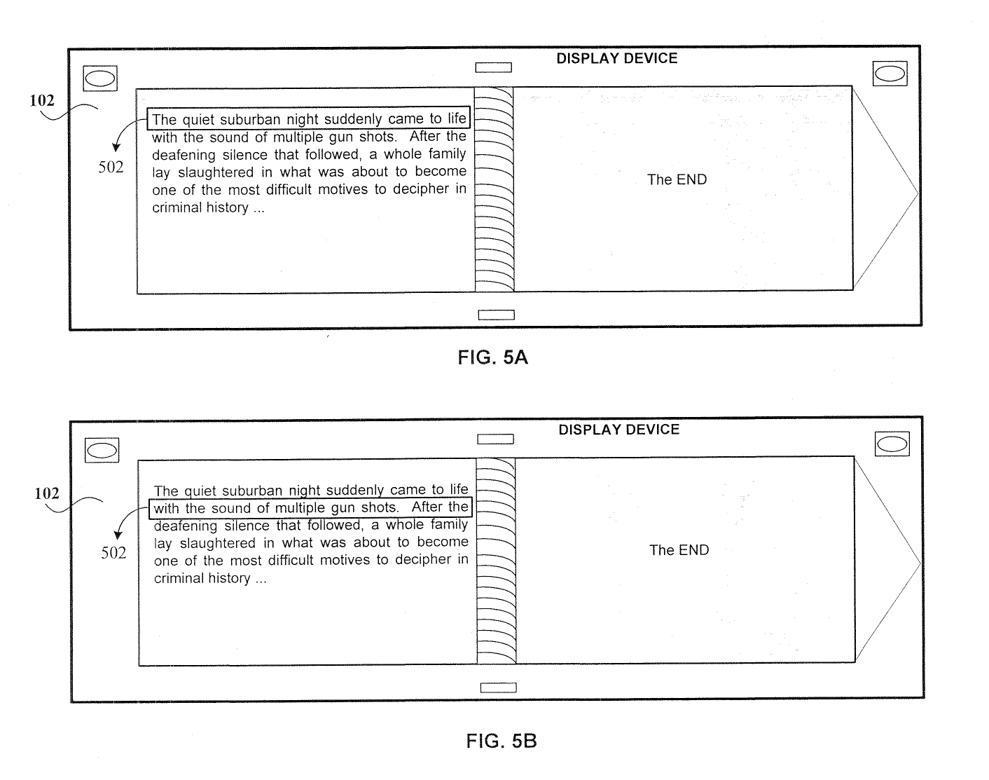

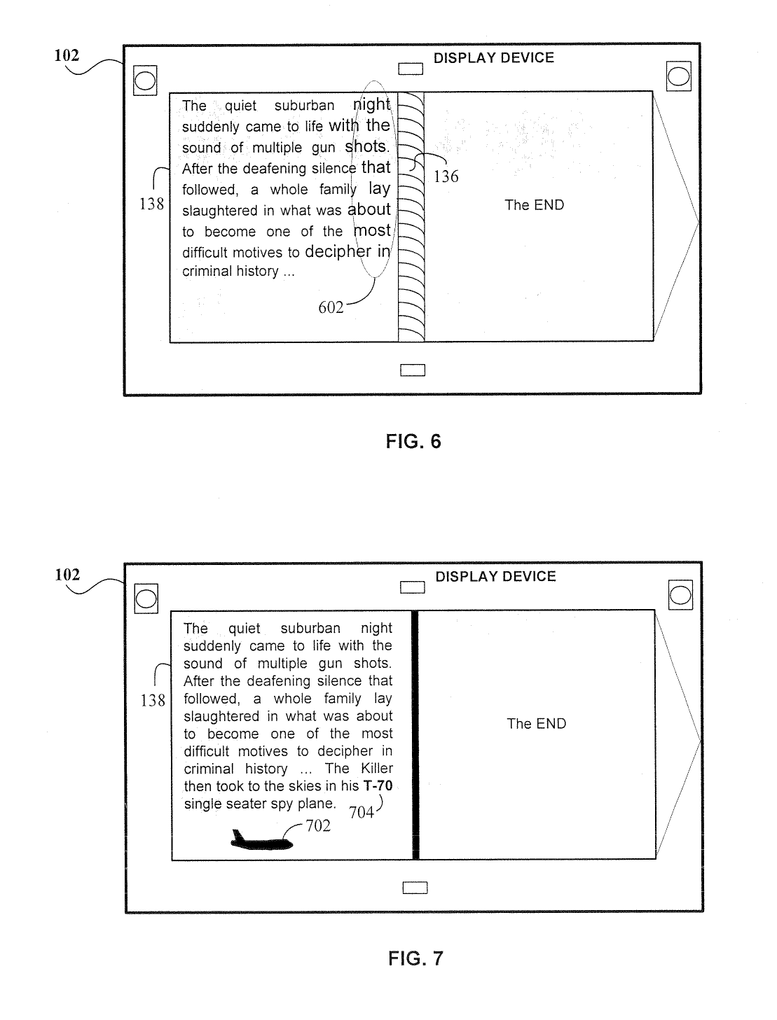

The plug-in effect processing unit 208 receives one or more programs, files, and/or data for updating or adding additional visual and/or audio effects to the image data via the effect plug-in (FIG. 1, element 122). By processing these programs, files, and/or data for updating or adding additional visual and/or audio effects, the plug-in effect processing unit 208 then provides the necessary programming to the GPU 216 for displaying such additional visual and/or audio effects. For example, referring to FIG. 6, the plug-in effect processing unit 208 (FIG. 2) may provide the necessary programming to the GPU 216 (FIG. 2) for increasing the text font of the displayed image data 602 that is in the vicinity of the graphically displayed center binding 136. Also, for example, referring to FIGS. 5A and 5B, the plug-in effect processing unit 208 (FIG. 2) may provide the necessary programming to the GPU 216 (FIG. 2) for generating a highlighted box 502 (FIG. 5A) around the text the user is predicted to be reading. The highlighted box 502 (FIG. 5B) moves to the next line of text that the user is predicted to be reading, as the user continues to read the text displayed by the image data.

The image recognition data receiving unit 210 receives processed image frames from the camera image processing unit 112 (FIG. 1). As previously described, the image processing unit (FIG. 1, element 112) may provide digital signal processing for determining, for example, the position of the user's head within each frame using image recognition techniques and providing a measure of the angular relationship between the user's head and the surface of the electronic display 102 (see FIG. 8). The image recognition data receiving unit 210 may receive the image recognition data that has been determined by the camera image processing unit (FIG. 1, element 112) for forwarding to the GPU 216. The image recognition data receiving unit 210 also receives real-time updates of incident light levels surrounding the electronic display 102 (FIG. 1). Also, the image recognition data receiving unit 210 can additionally provide image recognition and motion tracking such as detecting and tracking the movement of the user's eyes or other user features.

For example, the image recognition data receiving unit 210 may provide additional image recognition functionality such as the detection of eye movement (e.g., iris) as the user reads a page of displayed text. For example, the movement of the iris of the eye based on reading a page from top to bottom may be used as a reference movement. The actual movement of the iris of the user's eye is correlated with this reference movement in order to determine the location on the page of where the user is reading. The image recognition data receiving unit 210 may then provide the GPU 216 with predicted coordinate data for ascertaining the position of where (e.g., line of text) the user is reading with respect to the electronic display 102 (FIG. 1). The GPU 216 may use this predicted coordinate data in conjunction with, for example, the plug-in effect processing unit 208 so that the highlighted box 502 (see FIG. 5A) moves to the next line of text (see Figure SB) based on the predicted coordinate data.

According to another embodiment of the present invention, the predicted coordinate data may also be used as a dynamic bookmark, whereby if the user suddenly turns or moves away from the display 102 (FIG. 1), as indicated by, for example, a large detected change in iris or head position, the predicted line of text where the user is reading is highlighted. When the user wants to resume reading the text, they can easily locate the last line they have read by viewing the highlighted region of text.

The angle orientation and sensor data receiving unit 214 receives processed sensory information from the sensor unit 116 (FIG. 1). The received sensory information may be associated with sensing voice (e.g., microphone), acceleration (e.g., accelerometer), temperature (e.g., temperature sensor), and/or light (e.g., light sensor). For example, the angle orientation and sensor data receiving unit 214 may process a detected acceleration signal caused by the user (intentionally) shaking the device. Based on the acceleration signal, the angle orientation and sensor data receiving unit 214 subsequently sends the GPU 216 a “turn the page” command, which signals that the user is requesting the display of the next page of image data (e.g., displayed text). According to another example, the angle orientation and sensor data receiving unit 214 may process a detected voice signal caused by the user uttering a voice command such as “next page.” Based on the detected voice signal, the angle orientation and sensor data receiving unit 214 subsequently sends the GPU 216 a “turn the page” command, which signals that the user is requesting the display of the next page of image data (e.g., displayed text). The angle orientation and sensor data receiving unit 214 may also include an angular orientation sensor (not shown). If, for example, the user (intentionally) tilts the display 102 beyond a certain threshold angle (e.g., 40°), the angle orientation and sensor data receiving unit 214 subsequently sends the GPU 216 a “turn the page” command, which signals that the user is requesting the display of the next page of image data (e.g., displayed text). Based on the incorporation of one or more angular orientation sensors, the angle orientation and sensor data receiving unit 214 is able to detect the tilting of the electronic display 102 about one or more axes that pass within the plane of the display 102.

The GPU 216 includes a graphics shader unit 218 and an image display compensation unit 220. The graphics shader unit 218 provides the necessary instructions (e.g., software) for execution by the GPU 216. For example, the graphics shader unit 218 may include graphics software libraries such as OpenGL and Direct3D. The angle orientation and sensor data receiving unit 214 and the image recognition data receiving unit 210 provide the graphics shader unit 218 with programming and/or data associated with the user's head position, the incident light surrounding the display 102, and the angular orientation of the electronic display 102. The graphics shader unit 218 then utilizes the programming and/or data associated with the user's head position, the incident light surrounding the display 102, and the angular orientation of the electronic display 102 to render the image data resembling an actual paper medium on the electronic display, while compensating for changes in incident light levels and the user's head position relative to the electronic display (see FIGS. 8A-8D).

Referring to FIG. 8D, the user is optimally positioned when the user's head position relative to the display 102 is such that the angle (i.e., θ₀) between axis A, which passes within the surface of the display 102, and axis B, which extends from the user's head 802 to intersection point P with axis A, is approximate around 90°. It will be appreciated that this optimal angle (i.e., θ₀) may change based on the electronic display technology and/or display surface characteristics (e.g., curved or angled display). It may also be possible to vary optimal angle θ₀ to an angle that is either greater or less than 90° by providing graphical compensation via the graphics shader unit 218 (FIG. 2). In this case, the graphics shader unit 218 creates a visual effect on the display 102 that provides the user with the same visual effect as if they were viewing the display at the optimal angle θ₀ of about 90°. Likewise, as the user's head position relative to the display 102 deviates from the optimal angle θ₀, the graphics shader unit 218 creates a visual effect on the display 102 that provides the user with the same visual effect as if they were viewing the display at the optimal angle θ₀ of about 90°. The graphics shader unit 218 achieves this based on measuring both the angle between axis A and B (i.e., angle between user's head position and surface of electronic display 102) and the incident light levels (i.e., intensity) around the display 102.

Based on the changes in the traits (e.g., color, z depth, and/or alpha value) of each pixel on the display 102 as a result of incident light intensity changes and deviations from the optimal angle (i.e., θ₀), the graphics shader unit 218 provides the necessary programming/commands for accordingly correcting the changed traits in each pixel via the display driver unit 124 (FIGS. 1 and 2). These corrected changes are adapted to drive the pixels to exhibit the same traits as when the user's head position relative to the display 102 is optimally positioned. The graphics shader unit may 218 either correct each and every pixel or correct certain predefined pixels in order preserve processing power in the GPU 216.

The GPU 216 also includes the image display compensation unit 220. The image display compensation unit 220 provides real time compensation for the displayed images based on sudden changes in light intensity surrounding the display 102 (FIG. 1). For example, if the light levels suddenly increase, the image display compensation unit 220 accordingly intensifies the displayed images so that the user is able to see the displayed content clearly regardless of the increased background light. As the light levels suddenly decrease, the image display compensation unit 220 accordingly de-intensifies the displayed images.

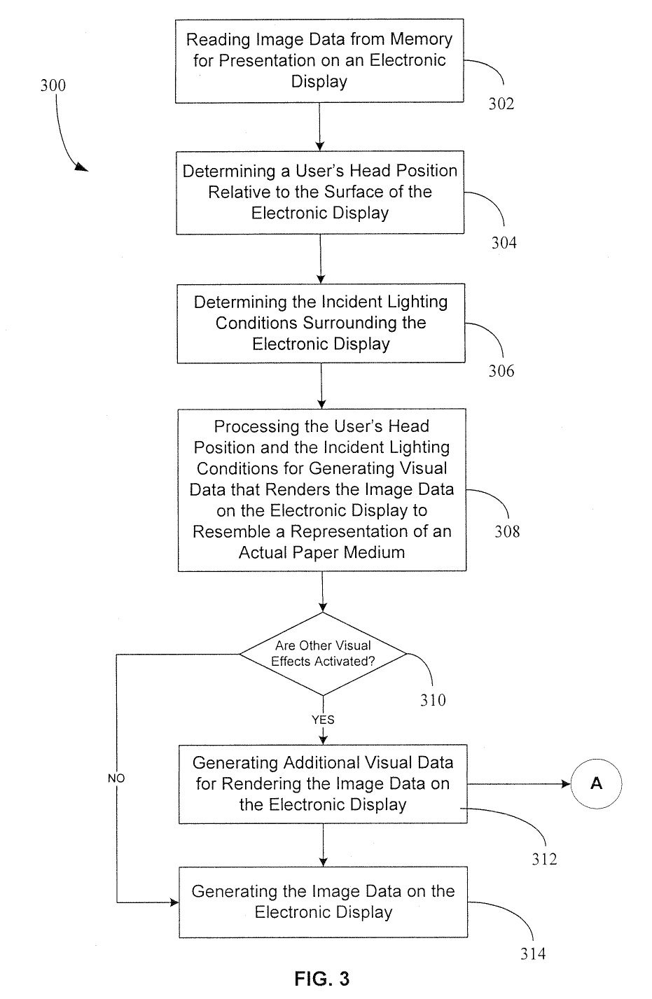

FIG. 3 is an operational flow diagram 300 according to an embodiment of the present invention. The steps of FIG. 3 show a process, which is for example, a series of steps, or program code, or algorithm stored on an electronic memory or computer-readable medium. For example, the steps of FIG. 3 may be stored on a computer-readable medium, such as ROM, RAM, EEPROM, CD, DVD, or other non-volatile memory or non-transitory computer-readable medium. The process may also be a module that includes an electronic memory, with program code stored thereon to perform the functionality. This memory is a structural article. As shown in FIG. 3, the series of steps may be represented as a flowchart that may be executed by a processor, processing unit, or otherwise executed to perform the identified functions and may also be stored in one or more memories and/or one or more electronic media and/or computer-readable media, which include non-transitory media as well as signals. The operational flow diagram 300 is described with the aid of the exemplary embodiments of FIGS. 1 and 2. At step 302, image data (e.g., e-book data) is read from a memory such as the image data storage unit 128 for processing by the image processing unit 104.

At step 304, the user's head position relative to the surface of the electronic display 102 is determined by utilizing, for example, the camera image receiving unit 110, the camera image processing unit 112, and the angle orientation and sensor data receiving unit 214 (i.e., display tilt detection). Also, using the camera image receiving unit 110 and the camera image processing unit 112, the incident light surrounding the electronic display is determined (step 306).

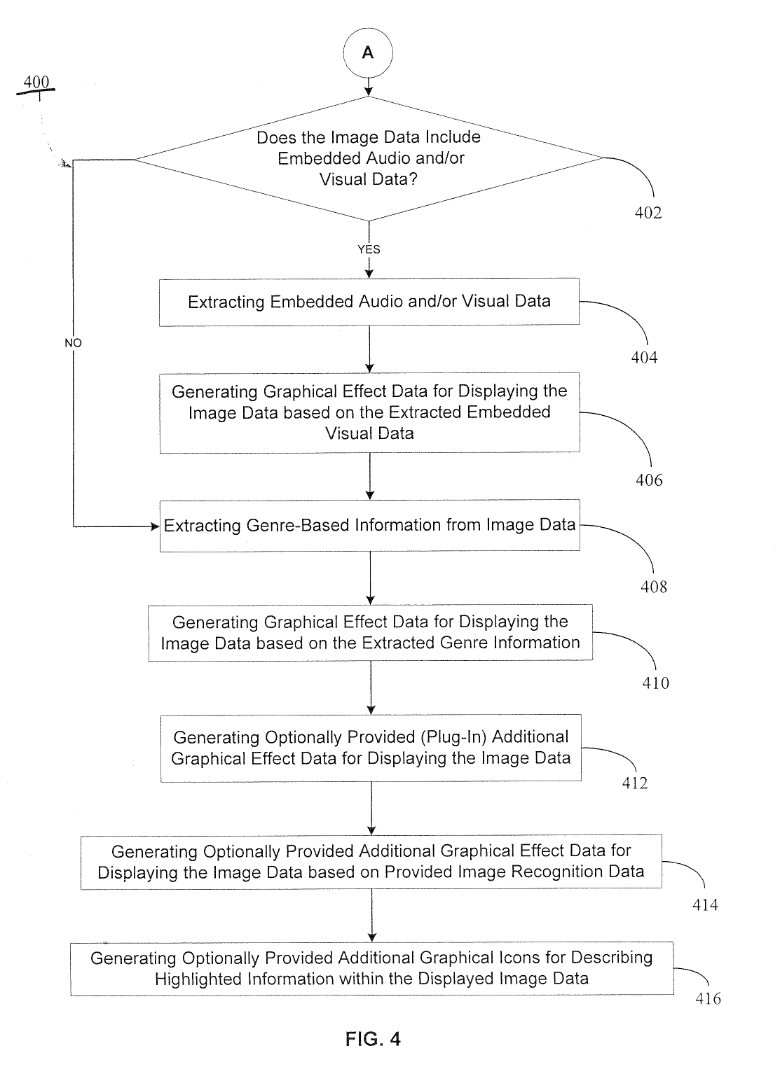

At step 308, the graphics shader unit 218 processes the user's determined head position and the measured incident lighting conditions (i.e., light intensity) surrounding the display 102 for generating visual data that renders the image data on the electronic display to resemble the representation of an actual paper medium. It is then determined whether other visual effects are activated or enabled (step 310). If the other additional visual effects are not activated or enabled (step 310), the processed image data (step 308) resembling the representation of an actual paper medium is displayed on the electronic display 102, as shown in step 314. If, however, the other additional visual effects are activated or enabled (step 310), additional visual data is provided for rendering the image data on the electronic display 102 (step 312). The additional visual data for rendering the image data on the display 102 is illustrated and described below by referring to FIG. 4.

FIG. 4 is an operational flow diagram 400 for describing the provision of additional visual data for rendering the image data on the display 102 according to an embodiment of the present invention. The steps of FIG. 4 show a process, which is for example, a series of steps, or program code, or algorithm stored on an electronic memory or computer-readable medium. For example, the steps of FIG. 4 may be stored on a computer-readable medium, such as ROM, RAM, EEPROM, CD, DVD, or other non-volatile memory or non-transitory computer-readable medium. The process may also be a module that includes an electronic memory, with program code stored thereon to perform the functionality. This memory is a structural article. As shown in FIG. 4, the series of steps may be represented as a flowchart that may be executed by a processor, processing unit, or otherwise executed to perform the identified functions and may also be stored in one or more memories and/or one or more electronic media and/or computer-readable media, which include non-transitory media as well as signals. At step 402, it is determined whether the image data includes embedded visual and/or audio data. If the image data includes embedded visual and/or audio data, the embedded visual and/or audio data is extracted from the image data using the embedded audio/visual processing unit 202 (step 404). Based on the extracted embedded visual and/or audio data, the graphics shader unit 218 generates the visual effects associated with the embedded visual data (step 406). These visual effects may, for example, include generated icons, added visual effects to the background, and/or visually altered displayed text (e.g., glowing text resembling fire). Any extracted embedded audio data is subsequently processed by the audio generation unit 212.

If the image data does not include embedded visual and/or audio data, genre information is extracted by the genre based processing unit 204 from the image data (step 408). The graphics shader unit 218 then generates corresponding graphical effect data (e.g., a gothic display theme for a horror genre) based on the extracted genre information (step 410).

At step 412, optionally provided additional graphical data may be provided for display with the image data by the plug-in effect processing unit 208. Based on the additional graphical data provided by the plug-in effect processing unit 208, the graphics shader unit 218 generates graphical effects corresponding to the existing plug-in effect provided by unit 208 (e.g., a 3-D background effect).

At step 414, other optionally provided additional graphical data may be added to the displayed image data based on the use of image recognition techniques. For example, the image recognition data receiving unit 210 may identify at least one eye of a user and track the movement of this eye in order to predict a location (e.g., a particular line of displayed text) on the display 102 which the user is observing. Once the predicted location is determined, the graphics shader unit 218 may, for example, generate a highlighted box 502 (see FIGS. 5A, 5B) around the corresponding text.

At step 416, further additional graphical data may also be added to the displayed image data in the form of graphical icons and/or highlighted (e.g., bolded) selectable (e.g., via cursor or touch screen) text. The icon generation unit 206 generates selectable icons or highlighted text based on certain words that exist in the text of the image data. Although FIG. 7 shows icons and highlighted text that are generated on the basis of extracted embedded data, the icon generation unit 206 may generate similar icons and highlighted text as that illustrated in FIG. 7. Thus, the icon generation unit 206 is adapted to generate icons based on the text displayed as well as adapted to generate one or more icons based on user input. Thus, the icon generation unit 206 is interactive based on user input.

Another embodiment of the present invention is directed to mounting a video camera on a device, such as a PLAYSTATION® that is adapted to sample ambient lighting and to modify the display characteristics based on the sensed ambient light. Thus, the camera, in addition to sensing a user's head position, is also used to sense ambient light. The camera may also be used to track the location of the reader device, typically utilizing GPS satellite locating techniques.

It is to be understood that the present invention can be implemented in various forms of hardware, software, firmware, special purpose processes, or a combination thereof. In one embodiment, at least parts of the present invention can be implemented in software tangibly embodied on a computer readable program storage device. The application program can be downloaded to, and executed by, any device comprising a suitable architecture.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

What is claimed is:

1. An apparatus comprising:
a display having a surface that displays image data;
a processing device for processing and providing image data to the display; and
a camera device associated with the display and operatively coupled to the processing device, the camera device dynamically detecting a user's head position relative to the surface of the display and determine incident light surrounding the display,
wherein the detected head position and the incident light are processed by the processing device for rendering the image data on the display to resemble a representation of an actual paper medium.

2. The apparatus according to claim 1, wherein the representation of an actual paper medium includes simulated lighting corresponding to a passively lit room.

3. The apparatus according to claim 1, wherein the representation of an actual paper medium includes at least one material property of an actual paper medium.

4. The apparatus according to claim 1, wherein the detected head position includes an angle between the user's head position and the surface of the display.

5. The apparatus according to claim 1, wherein the processing device comprises a graphics shader unit for rendering the image data on the display to resemble the representation of an actual paper medium.

6. The apparatus according to claim 1, wherein the processing device comprises a display compensation unit for compensating for display dimming that occurs with an increase in viewing angle between the user's head position relative to the surface of the display.

7. The apparatus according to claim 1, wherein the representation of an actual paper medium comprises at least one property of ink applied to an actual paper product.

8. The apparatus according to claim 1, wherein the display comprises a matte display surface for substantially matching a diffuse appearance associated with the actual printed paper.

9. The apparatus according to claim 1, wherein the camera device comprises an image recognition unit that is operable to detect the user's head position.

10. The apparatus according to claim 1, wherein the camera device comprises:
a first image recognition unit for detecting the user's head position; and
a second image recognition unit for tracking the user's eye position,
wherein based on the tracking of the user's eye position, the processing device provides enhanced lighting to a region of the display where the user is predicted to be observing.

11. The apparatus according to claim 1, wherein the camera device comprises:
a first image recognition unit for detecting the user's head position; and
a second image recognition unit for tracking the user's eye position, wherein based on the tracking of the user's eye position, the processing device provides:
shading to a first region of the display, wherein the first region is predicted to be unobserved by the user, and
modified lighting to a second region of the display where the user is predicted to be observing.

12. The apparatus according to claim 10, wherein the second image recognition unit comprises a timing unit operable to calculate a time period corresponding to an interval between the user changing page content associated with the display and advancing to a next page of content, the time period utilized in conjunction with the tracking of the user's eye position for increasing the accuracy of the region of the display where the user is predicted to be observing.

13. The apparatus according to claim 11, wherein the second image recognition unit comprises a timing unit operable to calculate a time period corresponding to an interval between the user changing page content associated with the display and advancing to a next page of content, the time period utilized in conjunction with the tracking of the user's eye position for increasing the accuracy of the region of the display where the user is predicted to be observing.

14. The apparatus according to claim 1, further comprising:
displaying one or more icons that are associated with additional data.

15. The apparatus according to claim 1, further comprising:
one or more audio links that when activated provide audio content.

16. The apparatus according to claim 15 wherein the audio content is associated with particular displayed text.

17. A method of controlling the appearance on a display having a surface that displays image data, the method comprising:
determining incident light levels surrounding the display;
determining a user's head position relative to the surface of the display; and
processing the incident light levels and the user's head position for rendering image data on the display that resembles a representation of an actual paper medium.

18. The method according to claim 17, wherein the rendering of the image data on the display comprises generating images that resemble the representation of an actual paper medium based on a genre of text displayed with the images.

19. The method according to claim 17, wherein the rendering of image data on the display that resemble the representation of an actual paper medium reduces the use's eye strain relative to the when the user reads content directly from a display that does not provide the rendering of image data for resembling the representation of an actual paper medium.

20. The method according to claim 17, wherein the determining of incident light levels comprises simulating lighting that corresponds to a passively lit room.

21. The method according to claim 17, wherein the determining of the user's head position comprises determining an angle between the user's head position and the surface of the display.

22. The method according to claim 17, further comprising:
compensating for display dimming based an increase in viewing angle between the user's head position relative to the surface of the display.

23. The method according to claim 17, further comprising:
determining the user's eye position; and
providing, based on the user's determined eye position, enhanced lighting to a first region of the display where the user is predicted to be observing.

24. The method according to claim 23, further comprising:
providing, based on the user's determined eye position, shading to a second region of the display where the user is predicted to not be observing.

25. The method according to claim 24, further comprising:
calculating a time period corresponding to an interval between the user changing page content associated with the display and advancing to a next page of content; and
predicting the region of the display where the user is observing based on the calculated time period and the user's determined eye position.

26. The method according to claim 25, further comprising:
providing a book genre; and
providing simulated effects based on the provided book genre.

27. The method according to claim 26, wherein the simulated effects include media data that is reproduced based on the user observing a particular one or more locations on the display that are determined by the predicting of the region of the display where the user is observing.

28. The method according to claim 25, further comprising:
saving the calculated time period with user-login information associated with the user; and
accessing the calculated time period upon the user entering the user-login information, wherein the accessed time period and a further eye position determination are utilized to predict the region of the display where the user is observing.

29. The method according to claim 17, further comprising:
providing a book genre; and
processing the book genre such that the rendered image data on the display resembles the representation of an actual paper medium corresponding to the provided book genre.

30. The method according to claim 17, wherein the processing further comprises:
graphically displayed a binding at approximately a middle location of the representation of an actual paper medium, wherein content data associated with the image data is enlarged in the proximity of the graphically displayed middle binding.

31. A non-transitory computer-readable recording medium for storing thereon a computer program for controlling the appearance on a display having a surface that displays image data, wherein the program comprises:
determining incident light levels surrounding the display;
determining a user's head position relative to the surface of the display; and
processing the incident light levels and the user's head position for rendering image data on the display that resembles a representation of an actual paper medium.

32. An apparatus comprising:
a display having a surface that displays image data;
a processing device for processing and providing image data to the display; and
a camera device associated with the display and communicatively coupled to the processing device, the camera device dynamically detecting changes in a user's head position and changes in movement of at least one of the user's eyes,
wherein the detected changes in the user's head position and the changes in the movement of at least one of the user's eyes are processed by the processing device and operable to provide a dynamic bookmark.

33. The apparatus according to claim 32, wherein the dynamic bookmark comprises a highlighted portion of displayed text that is determined based on the processing of the detected changes in the user's head position and the changes in the movement of at least one of the user's eyes.

34. The apparatus according to claim 1, wherein the processing device generates an environment map as a function of sensed light such that the map is used when the camera device is inoperative.
